(19) United States
(12) Patent Application Publication
(10) Pub. No.: US 2009/0085927 A1
(43) Pub. Date: Apr. 2, 2009

(54) LIQUID DISPLAY DEVICE DRIVING METHOD

(75) Inventor: Chulgyu Jung, Beijing (CN)

Correspondence Address: LADAS & PARRY LLP, 26 WEST 61ST STREET, NEW YORK, NY, 10023, US

(73) Assignee: BEIJING BOE OPTOELECTRONICS TECHNOLOGY., LTD.

(21) Appl. No.: 12/128,749

(22) Filed: May 29, 2008

(30) Foreign Application Priority Data
Sep. 27, 2007 (CN) 200710175208.7

(51) Int. Cl. G09G 3/36

(52) U.S. Cl. 345/606; 345/87

(57) ABSTRACT

The present invention directs to a liquid crystal display device driving method, comprising: compensating data line input voltages according to gate line numbers in which respective TFTs of a liquid crystal panel exist, and outputting the compensated data line input voltage to the liquid crystal panel. The present invention firstly compensates the input voltages according to the gate line numbers in which respective TFTs of the liquid crystal panel exist, and then outputs the compensated input voltages to respective lines of TFTs. The input voltages are gradually increased as the gate line numbers increasing, so as to ensure charging amount of pixels on all gate lines. A charging delay problem due to load difference between a near end and a far end of a high resolution and large size panel is resolved, the uniformity of the panel is ensured, and the display quality of image is improved.

### TECHNICAL FIELD

The present invention relates to a display device control method, particularly to a liquid crystal display device driving method.

### BACKGROUND ART

A thin film transistor liquid crystal display device (TFT-LCD) has features such as light weigh, thin thickness and low power consumption, and is widely applied in devices like cellular phones, displays and TV-sets. A TFT-LCD mainly comprises a liquid crystal panel, a gate driver, a data driver, and a time sequence controller and a backlight source. The liquid crystal panel is composed of an array substrate, a color film substrate and liquid crystal disposed therebetween. Data lines and gate lines are formed on the array substrate, TFTs disposed at the cross-points of the gate lines and the data lines are used to transfer data signals to the liquid crystal panel. The gate driver is used to provide pulse signals to the gate lines, and the data driver is used to provide data stream to the data lines. The backlight source is used to provide the liquid crystal panel with light, and comprises a light source, and an outer frame and a diffuse board enclosing the light source. The backlight source is controlled by inverters, and a plurality of backlight sources are initiated in turn under control of the inverters. The light passes through a reflect board and the diffuse board to emit in a direction toward liquid crystal panel. The time sequence controller is used to generate data line control signals and gate line control signals necessary for respective portions according to inputted synchronization signals (horizontal synchronization signals, vertical synchronization signals, data enable signals), and drives the inverters at the same time. The data driver converts inputted signals into data line input voltages necessary for the liquid crystal according to the control signals generated by the time sequence controller, and inputs them to the TFT. The inputted data works synchronously with the signals of the time sequence controller.

When using the above conventional TFT-LCD, there is a certain difference in working conditions of TFTs on different gate lines, especially in a large-sized panel with high resolution and heavy line load. In a same gate line driving time, different charging delays occur in pixels driven by TFTs on different gate lines. FIG. 5 is a schematic diagram illustrating voltages outputted to TFTs of respective gate line numbers according to the conventional art. As shown in FIG. 5, with respect to a first gate line G1 which is closest to an input terminal, the pixel charging delay is getting bigger as being departing from the input terminal due to a delay caused by a data line load, thus pixels on a n-th gate line that is farthest from the input terminal cannot reach a required charging amount within one line time (1H time), resulting in non-uniformity in the display panel, and affecting image displaying quality as a whole.

### SUMMARY OF THE INVENTION

An object of the present invention is to provide a liquid crystal display device driving method, which effectively resolves defects such as the displaying non-uniformity of a panel in the conventional liquid crystal display device due to the pixel charging delay.

To achieve the above object, the present invention provides a liquid crystal display device driving method, which comprises:

Step 1, compensating data line input voltages according to gate line numbers in which respective TFTs of a liquid crystal panel exist; and

Step 2, outputting the compensated data line input voltages to the liquid crystal panel.

Wherein, the step 1 further comprising:

Step 11, i=1, j=1;

Step 12, reading a data line input voltage of a j-th TFT on an i-th line;

Step 13, looking up a compensation value in a compensation table according to a gate line number in which said TFT exists and the data line input voltage;

Step 14, adding the compensation value to the data line input voltage of the j-th TFT on the i-th line, to form the compensated data line input voltage;

Step 15, determining whether j=m, if so performing step 17, otherwise performing step 16, wherein m is number of the TFTs in one line;

Step 16, j=j+1, performing step 12;

Step 17, determining whether i=n, if so performing step 19, otherwise performing step 18, wherein n is number of lines of the TFTsin the liquid crystal panel;

Step 18, i=i+1, performing step 12;

Step 19, completing compensation of the data line input voltages.

The present invention addresses the pixel charging delay problem caused by data line loads in the conventional liquid crystal display device, and proposes a liquid crystal display device driving method which can ensure pixel charging amount by means of input voltage compensation. The present invention firstly compensates input voltages according to gate line numbers in which respective TFTs of the liquid crystal panel exists, and then outputs the compensated input voltage to the TFTs in respective lines. The input voltages are gradually increased as the gate line numbers increases so as to ensure the charging amount of pixels on all the gate lines. The charging delay problem caused by a load difference between a near end and a far end of a high resolution and large-sized panel is solved by the above technical solution, so the uniformity of the panel is ensured, and the displaying quality of image is improved.

The technical solution of the present invention is described in detail by making reference to the accompanying figures and the embodiments.

### DESCRIPTION OF DRAWINGS

FIG. 1 is a flowchart of a liquid crystal display device driving method according to the present invention;

FIG. 2 is a flowchart of data line input voltage compensation according to the present invention;

FIG. 3 is a schematic diagram of voltages outputted to TFTs of respective gate line numbers according to the present invention;

FIG. 4 is a structural schematic diagram of a liquid crystal display device implementing the liquid crystal display device driving method according to the present invention; and

FIG. 5 is a schematic diagram of voltages outputted to TFTs of respective gate line numbers according to the prior art.

### DESCRIPTION OF THE REFERENCE SIGNS

10—liquid crystal panel; 11—gate line; 12—data line; 13—TFT; 20—time sequence control converter; 30—time sequence controller; 40—gate driver; 50—data driver.

### BEST MODE TO CARRY OUT THE INVENTION

Unless indicated otherwise, throughout the application documents of the present application, terminologies “a”, “an”, and “the” refer to “one or a plurality of and similarly, the component/element/means/module/unit/device and like described in a single form herein refer to “one or a plurality of such component/element/means/module/unit/device and like” and vice versa. Unless indicated otherwise, terminologies “include”, “comprise” and “contain” and their variants refer to “comprise but not limit to” throughout the application documents of the present application. Unless indicated otherwise, terminologies “an embodiment”, “the embodiment”, “embodiments”, “the embodiments”, “present embodiment”, “present embodiments”, “one or more embodiments” and “some embodiments” refer to one or more (but not all) embodiments throughout the application documents of the present application.

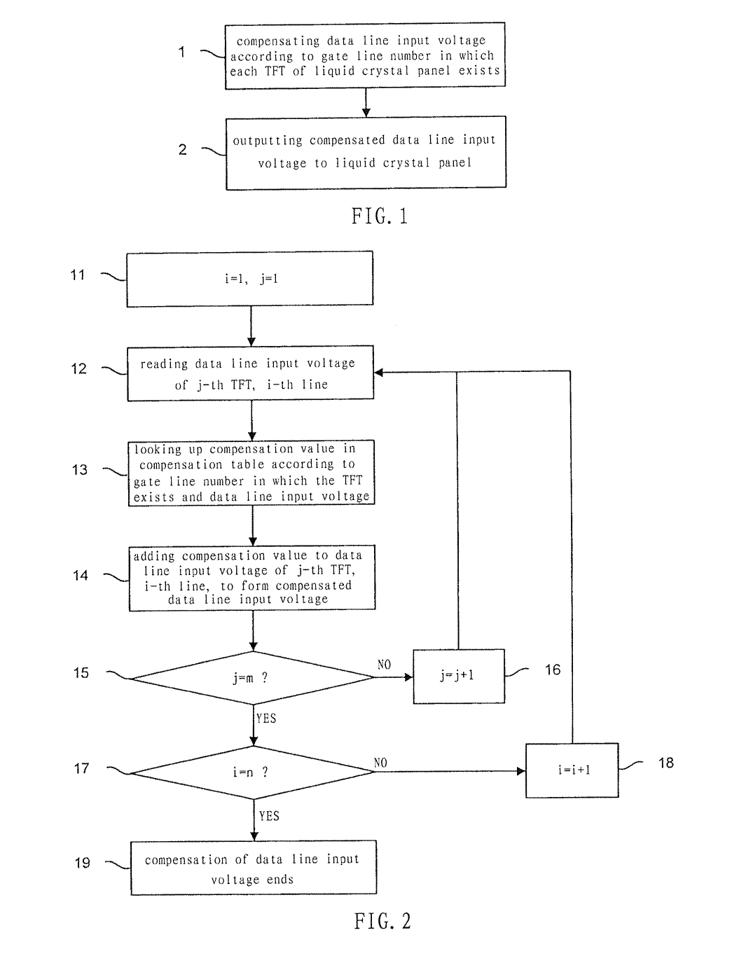

FIG. 1 is a flowchart of a liquid crystal display device driving method according to the present invention, comprising of:

Step 1, compensating data line input voltages according to gate line numbers in which respective TFTs of a liquid crystal panel exist; and

Step 2, outputting the compensated data line input voltages to the liquid crystal panel.

The liquid crystal display device driving method according to the present invention addresses the pixel charging delay problem caused by data line loads in a liquid crystal display device of the prior art, and proposes a technical solution that ensures pixel charging amount by compensating input voltages. The liquid crystal display device comprises a liquid crystal panel comprising gate lines arranged in rows and data lines arranged in columns, and wherein TFTs for driving pixels are formed at cross-points of the gate lines arranged in rows and the data lines arranged in columns, data line input voltages are inputted through the data lines to respective lines of the TFTs corresponding to respective gate lines arranged in rows, voltages are applied on respective TFTs and charge pixels thereat. Due to existence of the respective TFTs on the data lines, load of the data lines gradually increase. In order to compensate the pixel charging delay caused by the increasing load of the data lines, the present invention firstly compensates the input voltages according to the gate line numbers in which the respective TFTs of the liquid crystal panel exist, and then outputs the compensated input voltage to the respective lines of the TFTs, such that the pixels at the respective lines of the liquid crystal panel can reach required charging amount in the same time.

FIG. 2 is a flowchart of data line input voltage compensation according to the present invention, wherein:

Step 11, i=1, j=1;

Step 12, reading a data line input voltage of a j-th TFT on an i-th line;

Step 13, looking up a compensation value in a compensation table according to a gate line number in which the TFT exists and the data line input voltage;

Step 14, adding the compensation value to the data line input voltage of said j-th TFT on the i-th line, to form the compensated data line input voltage;

Step 15, determining whether j=m, if so performing step 17, otherwise performing step 16, wherein m is number of the TFTs in one line;

Step 16, j=j+1, performing step 12;

Step 17, determining whether i=n, if so performing step 19, otherwise performing step 18, wherein n is number of lines of the TFTs in the liquid crystal panel;

Step 18, i=i+1, performing step 12;

Step 19, completing compensation of the data line input voltage. In the technical solution illustrated in FIG. 2, the present invention sets up the compensation table which records the compensation values related to the gate line numbers in which the TFTs exist and the data line input voltages. Rows of the compensation table show the gate line numbers (1˜n) of the liquid crystal panel, and columns of the compensation table show the data line input voltages. The compensation table records the TFTs' compensation values corresponding to gate line numbers in which the TFTs exist and data line input voltages. The present invention reads in a data line input voltage of each TFT in each line of TFTs in turn, looks up the corresponding compensation value of the TFT according to the gate line number in which the TFT exists and the data line input voltage which the TFT has, and adds the thus obtained compensation value to the data line input voltage of the TFT to form a compensated data line input voltage. The compensated data line input voltage is outputted to the TFT on the respective line through a respective data line, and thus changes the voltage value applied on the TFT, so that the pixels at each line of the liquid crystal panel reach the required charging amount in the same time. The compensation table of the present invention can be obtained by experiments, and the compensation values in the compensation table are different depending on size, model, resolution and mode of the liquid crystal panel.

FIG. 3 is a schematic diagram of voltages outputted to TFTs of respective gate line numbers according to the present invention. As shown in FIG. 3, after being compensated, the data line input voltages outputted to the TFTs in the respective gate lines through the data lines are variable. As the gate line number increases, the load on the data line increases, therefore the outputted data line input voltage gradually increases so as to ensure the TFTs in all gate lines to reach the required charging amount in a gate driving time. Specifically, with respect to a first gate line G1, since the TFTs in this line are closest to an input terminal of the data lines, and the load is minimum, thus the outputted data line input voltage is relatively small; with respect to a 100-th gate line G100, since the TFTs in this line are far from the input terminal of the data lines, thus the data line input voltage outputted to the TFTs in this line is bigger than the data line input voltage outputted to the TFTs in the first gate line G1; with respect to a n-th gate line Gn, since the TFTs in this line are farthest from the input terminal of the data lines, and the load is maximum, thus the data line input voltage outputted to the TFTs in this line is maximum. By means of the above technical solution, the charging amount at end of the data lines is effectively ensured, such that the TFTs in all the gate lines reach the required charging amount in 1 H time, thus the uniformity of the panel is ensured, and the display quality of image is improved.

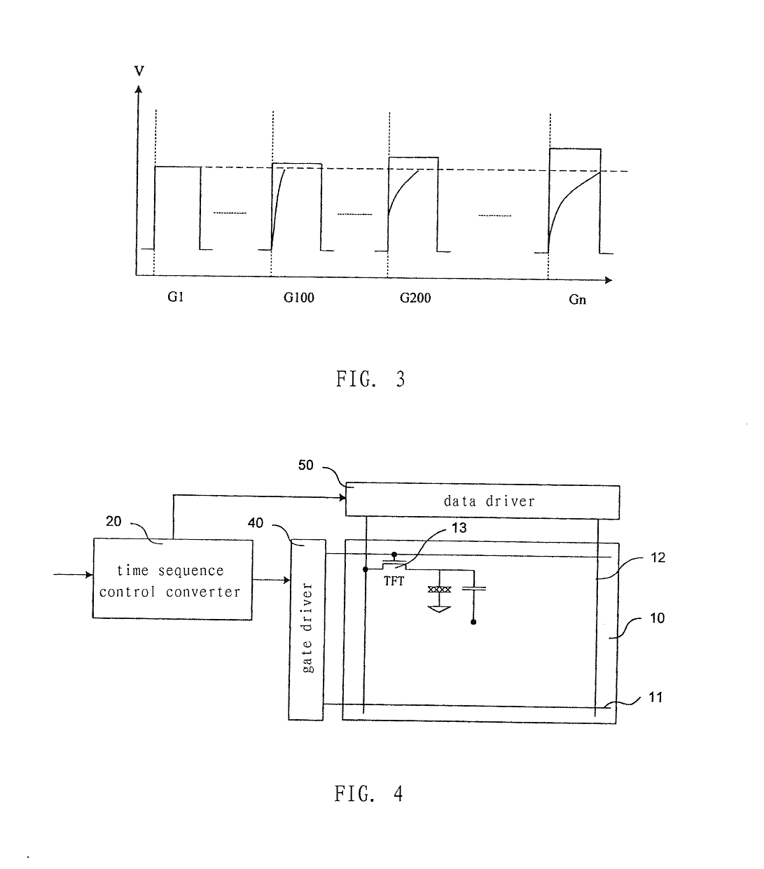

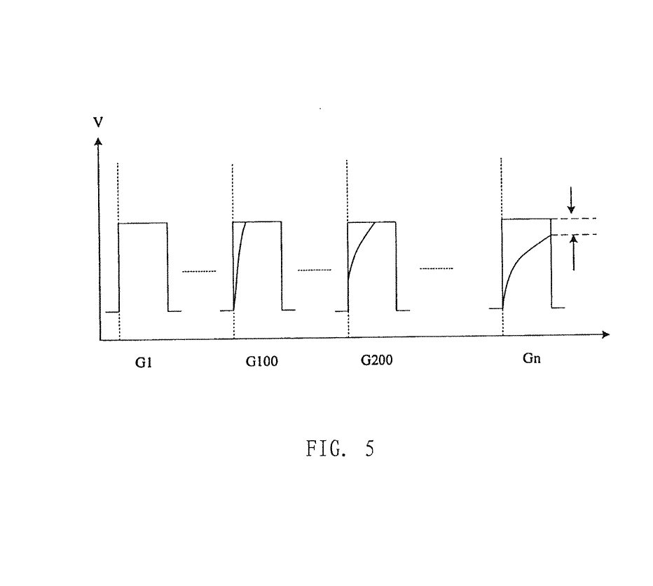

FIG. 4 is a structural schematic diagram of a liquid crystal display device implementing the liquid crystal display device driving method according to the present invention. As shown in FIG. 4, the liquid crystal display device comprises a liquid crystal panel 10, a time sequence control converter 20, a gate driver 40 and a data driver 50. The liquid crystal panel 10 comprises gate lines 11, data lines 12 and TFTs 13 formed at cross-point of the gate lines and the data lines; the time sequence control converter 20 is used to generate data line control signals and gate line control signals according to input synchronization signals; the gate driver 40 is coupled to the time sequence converter 20, and is used to generate gate line pulse signals according to the gate line control signals of the time sequence control converter 20, and input the same to the TFTs of the liquid crystal panel through the gate lines 11; the data driver 50 comprises a plurality of data driving modules coupled to the time sequence control converter 20, and is used to input the data line input voltages to the TFTs of the liquid crystal panel through the data lines 12 according to the data line control signals of the time sequence control converter 20.

In order to carry out the compensation of the data line input voltage, a data conversion module is disposed in the data driver of the present invention. The data conversion module is used to compensate the data line input voltages according to the gate line numbers in which respective TFTs of the liquid crystal panel exist, such that as the gate line number in which the TFT exists increasing, the data line input voltage value outputted by the data driver is gradually increased. Specifically, a compensation table is stored in the data conversion module of the present invention, which records the compensation values related to the gate line numbers in which the TFTs exist and the data line input voltages. Rows of the compensation table show the gate line numbers (1˜n) of the liquid crystal panel, and columns of the compensation table show the data line input voltages. The compensation table records the TFTs' compensation values corresponding to gate line numbers in which the TFTs exist and data line input voltages. The data conversion module reads in the data line input voltage of each TFT in respective lines of TFTs in turn, looks up the compensation value corresponding to the TFT according to the line number in which the TFT exists and the data line input voltage which the TFT has, adds the thus obtained compensation value to the data line input voltage of the TFT to form the compensated data line input voltage. The compensated data line input voltages are outputted to respective lines of TFTs through the data lines, and thus change the voltage values applied on the TFTs, so that the pixels at each line of the liquid crystal panel reach the required charging amount in the gate driving time, thus the uniformity of the panel is ensured, and the display quality of image is improved.

At last, it should be noted that, the embodiment is only for describing the technical solution of the present invention, but not for limitation, though the present invention is described in detail with reference to the preferred embodiments. Those of ordinary skills in the art will recognize that various changes and substations as to the technical solutions of the present invention can be made without departing from the scope and spirit of the technical solution of the invention.

1. A liquid crystal display device driving method, characterized in comprising:
Step 1, compensating data line input voltages according to gate line numbers in which respective TFTs of a liquid crystal panel exist; and
Step 2, outputting the compensated data line input voltages to the liquid crystal panel.

2. The liquid crystal display device driving method of claim 1, characterized in that the step 1 further comprises:
Step 11, i=1, j=1;
Step 12, reading a data line input voltage of a j-th TFT on an i-th line;
Step 13, looking up a compensation value in a compensation table according to a gate line number in which said TFT exists and the data line input voltage;
Step 14, adding the compensation value to the data line input voltage of the j -th TFT on the i-th line to form the compensated data line input voltage;
Step 15, determining whether j=m, if so performing step 17, otherwise performing step 16, wherein m is number of the TFTs in one line;
Step 16, j=j+1, performing step 12;
Step 17, determining whether i=n, if so performing step 19, otherwise performing step 18, wherein n is number of the lines of the TFTs;
Step 18, i=i+1, performing step 12;
Step 19, completing compensation of the data line input voltage.
